(19) United States
(12) Patent Application Publication
(10) Pub. No.: US 2013/0155543 A1
(43) Pub. Date: Jun. 20, 2013

(54) PATTERNED MAGNETIC RECORDING MEDIA AND METHODS OF PRODUCTION THEREOF UTILIZING CRYSTAL ORIENTATION CONTROL TECHNOLOGY

(71) Applicants: Yoshinori Honda, Hiratsuka-shi (JP); Yoshiyuki Hirayama, Tokyo (JP); Masayoshi Shimizu, Chigasaki-shi (JP); Taku Iwase, Tokyo (JP)

(72) Inventors: Yoshinori Honda, Hiratsuka-shi (JP); Yoshiyuki Hirayama, Tokyo (JP); Masayoshi Shimizu, Chigasaki-shi (JP); Taku Iwase, Tokyo (JP)

(73) Assignee: Hitachi Global Storage Technologies Netherlands B.V., Amsterdam (NL)

(21) Appl. No.: 13/327,702

(22) Filed: Dec. 15, 2011

(51) Int. Cl. G11B 21/02; G11B 5/667; B05D 5/12; G11B 5/66

(52) U.S. Cl. 360/75; 428/832; 428/828; 427/130; G9B/21.003

(57) ABSTRACT

In one embodiment, a patterned magnetic recording medium includes an interlayer positioned above a nonmagnetic substrate, wherein portions of the interlayer have good crystal orientation separated by portions of the interlayer which have poor crystal orientation, and a magnetic recording layer positioned above the interlayer. The magnetic recording layer is defined by a pattern which includes magnetic portions having good crystal orientation above the portions of the interlayer having good crystal orientation separated by magnetic portions having poor crystal orientation above the portions of the interlayer having poor crystal orientation. In another embodiment, a method is proposed for producing the patterned magnetic recording medium as described above which includes forming an interlayer and a recording layer above the interlayer, and imparting a template pattern to the interlayer using an organic resist during or after formation of the interlayer. The interlayer is adapted for controlling crystal orientation of the recording layer.

### FIELD OF THE INVENTION

The present application relates to patterned magnetic recording media for use in magnetic recording, and particularly to methods of producing patterned magnetic recording media employing crystal orientation control technology using surface modification.

### BACKGROUND

Research and development regarding magnetic disk drives, such as hard disk drives (HDDs) have focused recently on a patterned media as an approach for increasing the recording density and increasing the high density recording performance of magnetic disk drives.

Typically, for patterned media to be produced, the following processes may be performed in addition to the process for producing the conventional perpendicular magnetic recording medium. Some processes make use of a patterned method using dry etching or the like, while other processes make use of ion implantation. First, a desired resist pattern is formed above the conventional recording medium using an imprint process or lithography. An etching process is then carried out to process the resist which may utilize reactive etching in some cases. Then, the recording medium is etched according to the pattern. The magnetic film pattern formation process may use argon milling in some cases. Next, the mask is removed, which may utilize reactive etching, and a backfilling process is performed, which may utilize chemical vapor deposition (CVD) or some coating process. Then, planarization is carried out, which may utilize chemical mechanical polishing (CMP) or the like. Finally, a protection film is formed, and before use, a lubricant film is formed thereon.

In these methods, dry and wet processes are used, particles are produced in each step, and it is essential to carry out a cleaning step to clean the surface in order to maintain planarity to ensure a proper flying height. Therefore, production is fairly difficult, and yield and reliability need to be ensured to achieve the drastically lower flying height distance used by conventional magnetic heads which achieve high recording density. It is very difficult to respond to these requirements, and many samples do not achieve the desired result at some stage of processing.

Furthermore, the method employing ion implantation requires steps including: a step of forming a mask material with high ion collision resistance for implantation, a step of removing the highly resistant mask material after implantation, and a step of forming a final protective layer. Therefore, in this processing method, particles are produced, and it is essential to carry out a cleaning step to clean the surface in order to maintain planarity to ensure flying height tolerances can be met. Accordingly, production is fairly difficult, yield and reliability need to be ensured, and high-energy ion implantation equipment is required, as well as high-concentration implantation.

There are some problems with other conventional processes as well. Each process is complicated and there are a plurality of processes which must be performed to produce the patterned medium. Also, it is very difficult to obtain a proper thickness on a disk side using the filling and planarization processes, and uniformity of the pattern height across the medium surface may also vary. Furthermore, it is very difficult to obtain a pure surface which makes the very low flying height of a magnetic head above the disk surface possible after a mechanical polish, such as CMP. In addition, it is necessary to remove the particles generated in the various milling processes and reactive ion milling processes.

Accordingly, a method of producing a patterned magnetic medium which alleviates or eliminates these problems with conventional production methods would be very beneficial.

### SUMMARY

In one embodiment, a patterned magnetic recording medium includes an interlayer positioned above a nonmagnetic substrate, wherein portions of the interlayer have good crystal orientation and are separated by portions of the interlayer which have poor crystal orientation and a magnetic recording layer positioned above the interlayer, wherein the magnetic recording layer is defined by a pattern which includes magnetic portions having good crystal orientation above the portions of the interlayer having good crystal orientation which are separated by magnetic portions having poor crystal orientation above the portions of the interlayer having poor crystal orientation.

In another embodiment, a method for producing a patterned magnetic recording medium includes forming a nonmagnetic substrate free of soiling and particles, forming an interlayer above the nonmagnetic substrate, forming a magnetic recording layer above the interlayer, and imparting a template pattern to the interlayer using an organic resist while the interlayer is being formed or after formation thereof, wherein the interlayer is adapted for controlling a crystal orientation of the magnetic recording layer.

Any of these embodiments may be implemented in a magnetic data storage system such as a disk drive system, which may include a magnetic head, a drive mechanism for passing a magnetic storage medium (e.g., hard disk) over the head, and a control unit electrically coupled to the head for controlling operation of the head.

Other aspects and advantages of the present invention will become apparent from the following detailed description, which, when taken in conjunction with the drawings, illustrate by way of example the principles of the invention.

### BRIEF DESCRIPTION OF THE DRAWINGS

FIG. 1 is a simplified drawing of a magnetic recording disk drive system.

FIG. 2A is a schematic representation in section of a recording medium utilizing a longitudinal recording format.

FIG. 2B is a schematic representation of a conventional magnetic recording head and recording medium combination for longitudinal recording as in FIG. 2A.

FIG. 2C is a magnetic recording medium utilizing a perpendicular recording format.

FIG. 2D is a schematic representation of a recording head and recording medium combination for perpendicular recording on one side.

FIG. 2E is a schematic representation of a recording apparatus adapted for recording separately on both sides of the medium.

FIG. 3A is a cross-sectional view of one particular embodiment of a perpendicular magnetic head with helical coils.

FIG. 3B is a cross-sectional view of one particular embodiment of a piggyback magnetic head with helical coils.

FIG. 4A is a cross-sectional view of one particular embodiment of a perpendicular magnetic head with looped coils.

FIG. 4B is a cross-sectional view of one particular embodiment of a piggyback magnetic head with looped coils.

FIGS. 5A-5D show a method of producing a patterned magnetic recording medium according to one embodiment.

FIGS. 6A-6B show a magnetic recording medium having good and poor crystal orientation, respectively.

FIGS. 7A-7B show actual results from measuring magnetic characteristics of a patterned magnetic medium, according to some embodiments.

FIG. 8 shows AFM/MFM scans of actual patterned magnetic media, according to one embodiment.

FIGS. 9A-9C show patterned magnetic media according to various embodiments.

FIG. 10 shows detailed layer structures used in exemplary embodiments.

FIG. 11 shows a flow chart of a method, according to one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an,” and “the” include plural referents unless otherwise specified.

In one general embodiment, a patterned magnetic recording medium includes an interlayer positioned above a nonmagnetic substrate, wherein portions of the interlayer have good crystal orientation and are separated by portions of the interlayer which have poor crystal orientation and a magnetic recording layer positioned above the interlayer, wherein the magnetic recording layer is defined by a pattern which includes magnetic portions having good crystal orientation above the portions of the interlayer having good crystal orientation which are separated by magnetic portions having poor crystal orientation above the portions of the interlayer having poor crystal orientation.

In another general embodiment, a method for producing a patterned magnetic recording medium includes forming a nonmagnetic substrate free of soiling and particles, forming an interlayer above the nonmagnetic substrate, forming a magnetic recording layer above the interlayer, and imparting a template pattern to the interlayer using an organic resist while the interlayer is being formed or after formation thereof, wherein the interlayer is adapted for controlling a crystal orientation of the magnetic recording layer.

The issues with conventional patterned media processing technology have been described previously. By dispensing with the complex steps of this conventional processing technology and by providing a structure for a patterned magnetic recording medium and a method for forming the patterned magnetic recording medium which are very reliable, the problems associated with conventional processing technology may be minimized or eliminated.

There are particular problems with magnetic film processing methods in conventional processes for forming a magnetic pattern, in that the magnetic characteristics, which are an intrinsic feature of the magnetic film used in the magnetic medium, are reduced as the pattern becomes smaller in size (thickness decreases), and the crystals in the magnetic film are destroyed by the physical processing method.

Furthermore, with conventional ion implantation methods used in conventional processes for forming a magnetic pattern, due to implantation amount control and implantation depth control, the film and the crystal grains previously formed are destroyed by the physical implantation of ions, and deformation occurs as the mass increases. Therefore, not only does this impair the flying properties of a finished magnetic disk drive which are required in its use, it is also impossible to maintain a stable state due to diffusion of the implanted ions within the magnetic film which accompanies ion implantation, which causes the magnetic characteristics to change over time. Furthermore, this disturbs the magnetic pattern boundary, so the recording pattern can no longer be maintained.

The issues that inhibit magnetic medium production include and are shared by all conventional technologies are that the crystals in the magnetic layer are destroyed, and the steps for production are complex and the magnetic disk medium requires cleaning, so that it is not possible to obtain a surface which allows very low flying of the magnetic head, which is necessary for high density recording.

In order to overcome the problems of the prior art, selective self-growth of the magnetic crystals is used in some embodiments. That is, if the surface energy of the magnetic underlayer is selectively varied, then it is possible to form a place where the magnetic crystals undergo epitaxial growth and a place where the crystals do not readily grow, and this may be used to form a pattern from which a patterned recording medium may be formed. A continuous film may be formed in the same way as in a conventional process for forming a patterned medium from the magnetic film forming process to the protective film forming process, including all formation processes therebetween, so there is no need for the intermediate particle removal and cleaning processes of the conventional technology which are replete with problems, and it is possible to provide a very reliable medium which allows for a very low flying height distance, in some approaches. Furthermore, reliability and yield may be further improved because the complex conventional processes are simplified or eliminated, in preferred embodiments.

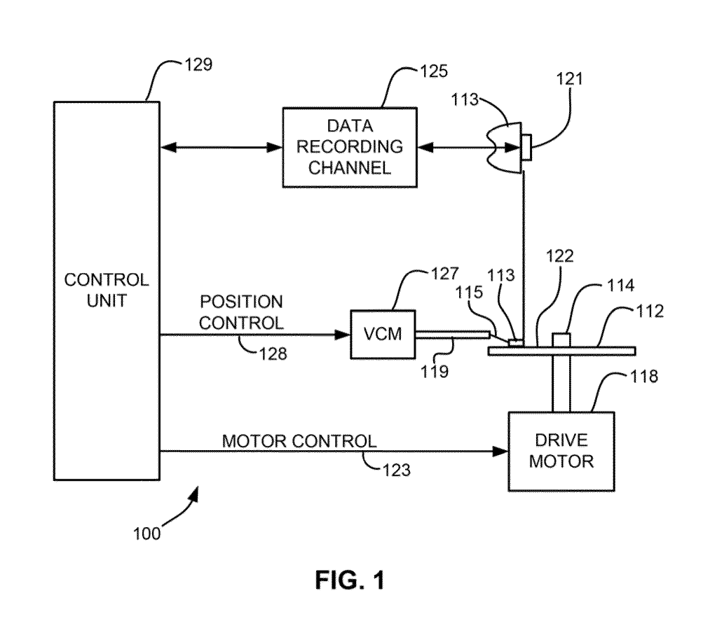

Referring now to FIG. 1, there is shown a disk drive 100 in accordance with one embodiment of the present invention. As shown in FIG. 1, at least one rotatable magnetic disk 112 is supported on a spindle 114 and rotated by a disk drive motor 118. The magnetic recording on each disk is typically in the form of an annular pattern of concentric data tracks (not shown) on the disk 112.

At least one slider 113 is positioned near the disk 112, each slider 113 supporting one or more magnetic read/write heads 121. As the disk rotates, slider 113 is moved radially in and out over disk surface 122 so that heads 121 may access different tracks of the disk where desired data are recorded and/or to be written. Each slider 113 is attached to an actuator arm 119 by means of a suspension 115. The suspension 115 provides a slight spring force which biases slider 113 against the disk surface 122. Each actuator arm 119 is attached to an actuator 127. The actuator 127 as shown in FIG. 1 may be a voice coil motor (VCM). The VCM comprises a coil movable within a fixed magnetic field, the direction and speed of the coil movements being controlled by the motor current signals supplied by controller 129.

During operation of the disk storage system, the rotation of disk 112 generates an air bearing between slider 113 and disk surface 122 which exerts an upward force or lift on the slider. The air bearing thus counter-balances the slight spring force of suspension 115 and supports slider 113 off and slightly above the disk surface by a small, substantially constant spacing during normal operation. Note that in some embodiments, the slider 113 may slide along the disk surface 122.

The various components of the disk storage system are controlled in operation by control signals generated by control unit 129, such as access control signals and internal clock signals. Typically, control unit 129 comprises logic control circuits, storage (e.g., memory), and a microprocessor. The control unit 129 generates control signals to control various system operations such as drive motor control signals on line 123 and head position and seek control signals on line 128. The control signals on line 128 provide the desired current profiles to optimally move and position slider 113 to the desired data track on disk 112. Read and write signals are communicated to and from read/write heads 121 by way of recording channel 125.

The above description of a typical magnetic disk storage system, and the accompanying illustration of FIG. 1 is for representation purposes only. It should be apparent that disk storage systems may contain a large number of disks and actuators, and each actuator may support a number of sliders.

An interface may also be provided for communication between the disk drive and a host (integral or external) to send and receive the data and for controlling the operation of the disk drive and communicating the status of the disk drive to the host, all as will be understood by those of skill in the art.

In a typical head, an inductive write head includes a coil layer embedded in one or more insulation layers (insulation stack), the insulation stack being located between first and second pole piece layers. A gap is formed between the first and second pole piece layers by a gap layer at an air bearing surface (ABS) of the write head. The pole piece layers may be connected at a back gap. Currents are conducted through the coil layer, which produce magnetic fields in the pole pieces. The magnetic fields fringe across the gap at the ABS for the purpose of writing bits of magnetic field information in tracks on moving media, such as in circular tracks on a rotating magnetic disk.

The second pole piece layer has a pole tip portion which extends from the ABS to a flare point and a yoke portion which extends from the flare point to the back gap. The flare point is where the second pole piece begins to widen (flare) to form the yoke. The placement of the flare point directly affects the magnitude of the magnetic field produced to write information on the recording medium.

According to one illustrative embodiment, a magnetic data storage system may comprise at least one magnetic head as described herein according to any embodiment, a magnetic medium, a drive mechanism for passing the magnetic medium over the at least one magnetic head, and a controller electrically coupled to the at least one magnetic head for controlling operation of the at least one magnetic head.

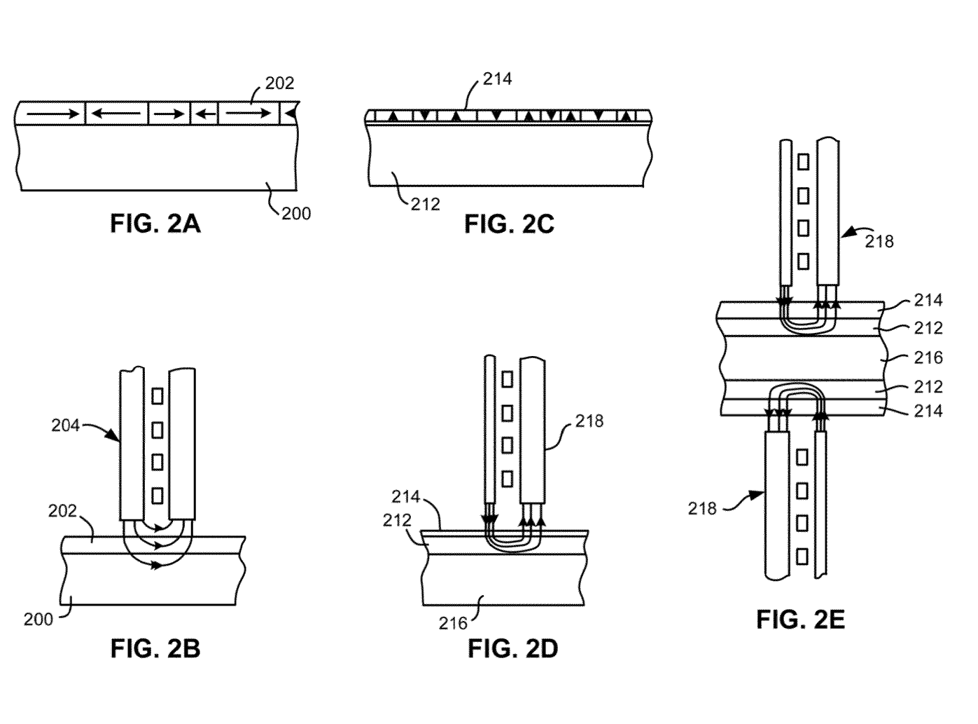

FIG. 2A illustrates, schematically, a conventional recording medium such as used with magnetic disc recording systems, such as that shown in FIG. 1. This medium is utilized for recording magnetic impulses in or parallel to the plane of the medium itself. The recording medium, a recording disc in this instance, comprises basically a supporting substrate 200 of a suitable non-magnetic material such as glass, with an overlying coating 202 of a suitable and conventional magnetic layer.

FIG. 2B shows the operative relationship between a conventional recording/playback head 204, which may preferably be a thin film head, and a conventional recording medium, such as that of FIG. 2A.

FIG. 2C illustrates, schematically, the orientation of magnetic impulses substantially perpendicular to the surface of a recording medium as used with magnetic disc recording systems, such as that shown in FIG. 1. For such perpendicular recording the medium typically includes an under layer 212 of a material having a high magnetic permeability. This under layer 212 is then provided with an overlying coating 214 of magnetic material preferably having a high coercivity relative to the under layer 212.

FIG. 2D illustrates the operative relationship between a perpendicular head 218 and a recording medium. The recording medium illustrated in FIG. 2D includes both the high permeability under layer 212 and the overlying coating 214 of magnetic material described with respect to FIG. 2C above. However, both of these layers 212 and 214 are shown applied to a suitable substrate 216. Typically there is also an additional layer (not shown) called an “exchange-break” layer or “interlayer” between layers 212 and 214.

In this structure, the magnetic lines of flux extending between the poles of the perpendicular head 218 loop into and out of the overlying coating 214 of the recording medium with the high permeability under layer 212 of the recording medium causing the lines of flux to pass through the overlying coating 214 in a direction generally perpendicular to the surface of the medium to record information in the overlying coating 214 of magnetic material preferably having a high coercivity relative to the under layer 212 in the form of magnetic impulses having their axes of magnetization substantially perpendicular to the surface of the medium. The flux is channeled by the soft underlying coating 212 back to the return layer (P1) of the head 218.

FIG. 2E illustrates a similar structure in which the substrate 216 carries the layers 212 and 214 on each of its two opposed sides, with suitable recording heads 218 positioned adjacent the outer surface of the magnetic coating 214 on each side of the medium, allowing for recording on each side of the medium.

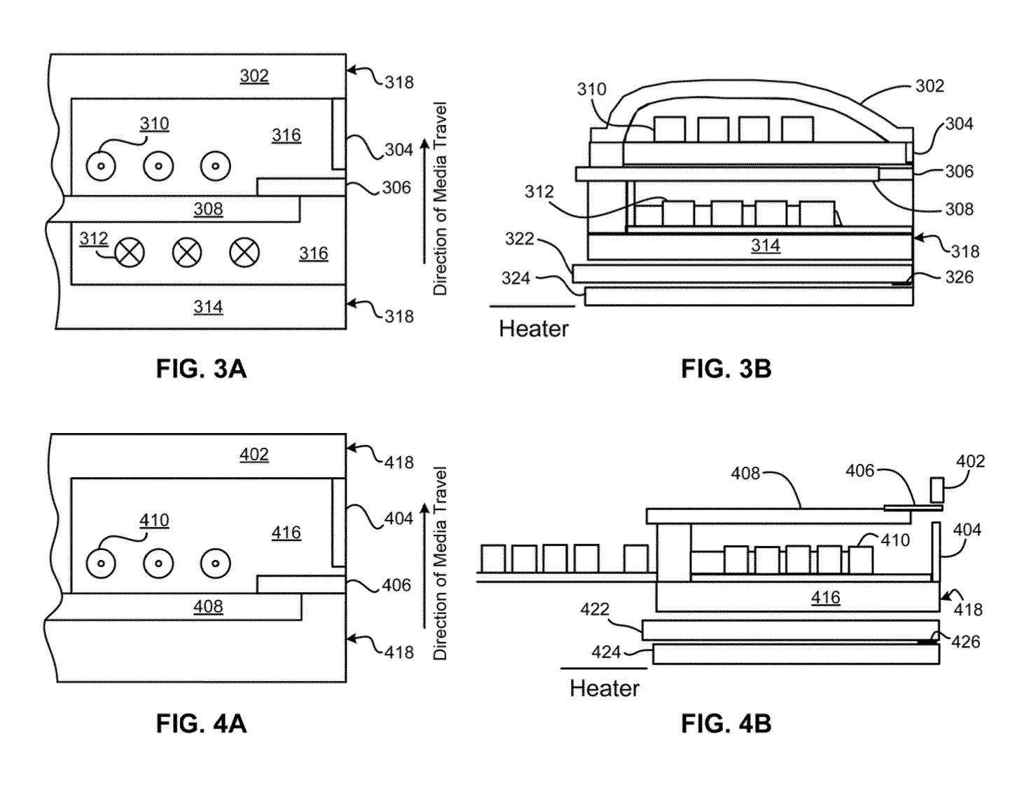

FIG. 3A is a cross-sectional view of a perpendicular magnetic head. In FIG. 3A, helical coils 310 and 312 are used to create magnetic flux in the stitch pole 308, which then delivers that flux to the main pole 306. Coils 310 indicate coils extending out from the page, while coils 312 indicate coils extending into the page. Stitch pole 308 may be recessed from the ABS 318. Insulation 316 surrounds the coils and may provide support for some of the elements. The direction of the media travel, as indicated by the arrow to the right of the structure, moves the media past the lower return pole 314 first, then past the stitch pole 308, main pole 306, trailing shield 304 which may be connected to the wrap around shield (not shown), and finally past the upper return pole 302. Each of these components may have a portion in contact with the ABS 318. The ABS 318 is indicated across the right side of the structure.

Perpendicular writing is achieved by forcing flux through the stitch pole 308 into the main pole 306 and then to the surface of the disk positioned towards the ABS 318.

FIG. 3B illustrates a piggyback magnetic head having similar features to the head of FIG. 3A. Two shields 304, 314 flank the stitch pole 308 and main pole 306. Also sensor shields 322, 324 are shown. The sensor 326 is typically positioned between the sensor shields 322, 324.

FIG. 4A is a schematic diagram of one embodiment which uses looped coils 410, sometimes referred to as a pancake configuration, to provide flux to the stitch pole 408. The stitch pole then provides this flux to the main pole 406. In this orientation, the lower return pole is optional. Insulation 416 surrounds the coils 410, and may provide support for the stitch pole 408 and main pole 406. The stitch pole may be recessed from the ABS 418. The direction of the media travel, as indicated by the arrow to the right of the structure, moves the media past the stitch pole 408, main pole 406, trailing shield 404 which may be connected to the wrap around shield (not shown), and finally past the upper return pole 402 (all of which may or may not have a portion in contact with the ABS 418). The ABS 418 is indicated across the right side of the structure. The trailing shield 404 may be in contact with the main pole 406 in some embodiments.

FIG. 4B illustrates another type of piggyback magnetic head having similar features to the head of FIG. 4A including a looped coil 410, which wraps around to form a pancake coil. Also, sensor shields 422, 424 are shown. The sensor 426 is typically positioned between the sensor shields 422, 424.

In FIGS. 3B and 4B, an optional heater is shown near the non-ABS side of the magnetic head. A heater element (Heater) may also be included in the magnetic heads shown in FIGS. 3A and 4A. The position of this heater may vary based on design parameters such as where the protrusion is desired, coefficients of thermal expansion of the surrounding layers, etc.

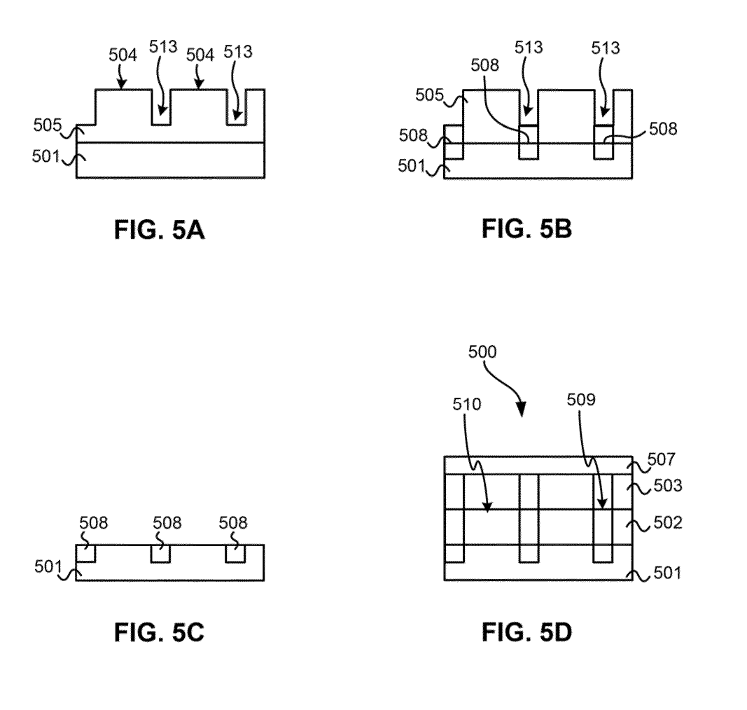

A stable and reliable structure for a patterned magnetic recording medium and a method for forming the same is described below in reference to FIGS. 5-12, which overcome the problems of the conventional technology described above.

Referring to FIGS. 5A-5D, a method for forming a patterned magnetic medium 500 is shown according to one embodiment. In order to form the patterned magnetic medium 500, a magnetic film is continuously formed using any suitable method known in the art, such as those described herein or any others. This magnetic film may comprise any number of layers, which are not shown for simplicity, but it is noted that the magnetic film is formed up to an interlayer 501 which will be positioned below a magnetic recording layer, which is formed later. An imprint resist 505 is formed above the interlayer 501, and may be formed in such a way that resist projections 504 form a pattern in the imprint resist 505 along with the shallow regions 513 which coincide with a desired magnetic pattern of the magnetic recording layer. Then, as shown in FIG. 5B, the structure, including the imprint resist 505 and the interlayer 501 is exposed to ion treatment to modify the surface of the interlayer 501 and form a modified layer 508 which forms at portions of the interlayer 501 where the imprint resist 505 has the least thickness (the shallow regions). Then, as shown in FIG. 5C, the imprint resist 505 is removed using any suitable method known in the art, which leaves the interlayer 501 and the modified layer 508. Then, as shown in FIG. 5D, a magnetic recording layer 502, a cap layer 503, and a protective layer 507 are formed in succession in order to form the patterned magnetic recording medium 500. According to one embodiment, the number of steps or operations involved in this process is halved when compared with the conventional technology.

The magnetic characteristics of a perpendicular magnetic recording layer is affected by the crystal orientation properties of one or more layers positioned below the magnetic recording layer, such as an interlayer, which may comprise ruthenium (Ru), which may be used as a crystal control layer and is positioned below the magnetic recording layer. Portions of a magnetic layer may be altered such that these portions do not contribute to magnetic recording if the crystal orientation of the magnetic film is disrupted in these portions. This disruption may be achieved by disrupting the crystal orientation of the interlayer positioned below the magnetic recording layer.

In FIG. 5B, according to one embodiment, a high concentration of ions may be introduced into the shallow regions 513 at the surface of the interlayer 501. The interlayer 501 may comprise Ru or any other suitable material as would be known to one of skill in the art. The ions may comprise any suitable material, such as nitrogen (N), oxygen (O), fluorine (F), argon (Ar), helium (He), neon (Ne), krypton (Kr), xenon (Xe), carbon (C) and/or boron (B) ions, or any other ions as would be known to one of skill in the art that are capable of disrupting the crystal orientation of the interlayer 501. This causes epitaxial growth above the modified layer 508 to be partially blocked when the magnetic recording layer 502 is subsequently formed thereon, as shown in FIG. 5D, and as a result it is possible to form the pattern of the magnetic recording layer 502.

In one approach, the modified portions 508 of the interlayer 501 having poor crystal orientation may only extend for a portion of a thickness of the interlayer from an upper surface thereof towards a lower surface thereof. In another approach, the portions 508 of the interlayer 501 having poor crystal orientation may have ions implanted therein.

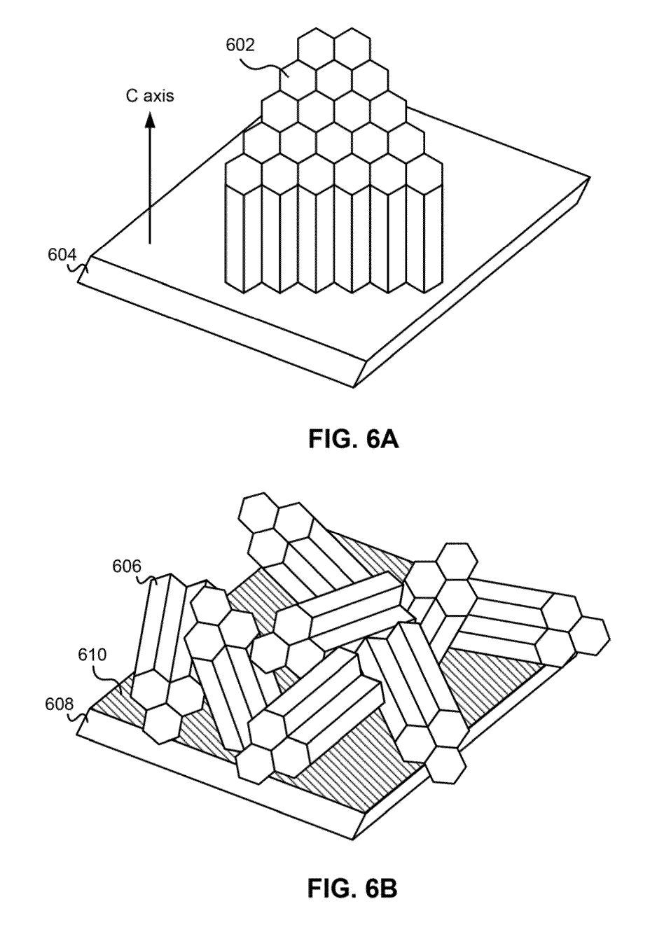

Specifically, as shown in FIGS. 6A-6B, schematic drawings of the magnetic layer crystal orientation are shown according to one embodiment. In FIG. 6A, a magnetic film 602 having an ordered orientation having good crystal orientation with the C-axis substantially perpendicularly oriented relative to a plane of formation of the magnetic film 602 is shown after being formed on an interlayer 604, where there is no nitrogen or other ions present at the surface. By “good crystal orientation” what is meant is that substantially all of the crystals are oriented with their longitudinal axes about perpendicularly oriented relative to a plane of formation of the magnetic film 602, e.g., substantially parallel to the C-axis line shown in FIG. 6A. In FIG. 6B, a magnetic film 606 having poor and random crystal orientation is shown after being formed on a surface of an interlayer 608 where nitrogen or some other suitable doping material 610 is present at or near the surface of the interlayer 608 or at an interface of the interlayer 608. What is meant by “poor crystal orientation” is that the crystals are not oriented in any particular direction, or are primarily oriented in a direction substantially inconsistent with the desired orientation for the layer. One way of having poor crystal orientation is to be amorphous, but inconsistent and random crystal orientation to this extent is not required to constitute “poor crystal orientation”. As a result of being formed above the interlayer 604 as shown in FIG. 6A, a magnetic pattern is automatically formed, whereas one is not formed so easily above the interlayer 608 of FIG. 6B which has been treated with a suitable doping material.

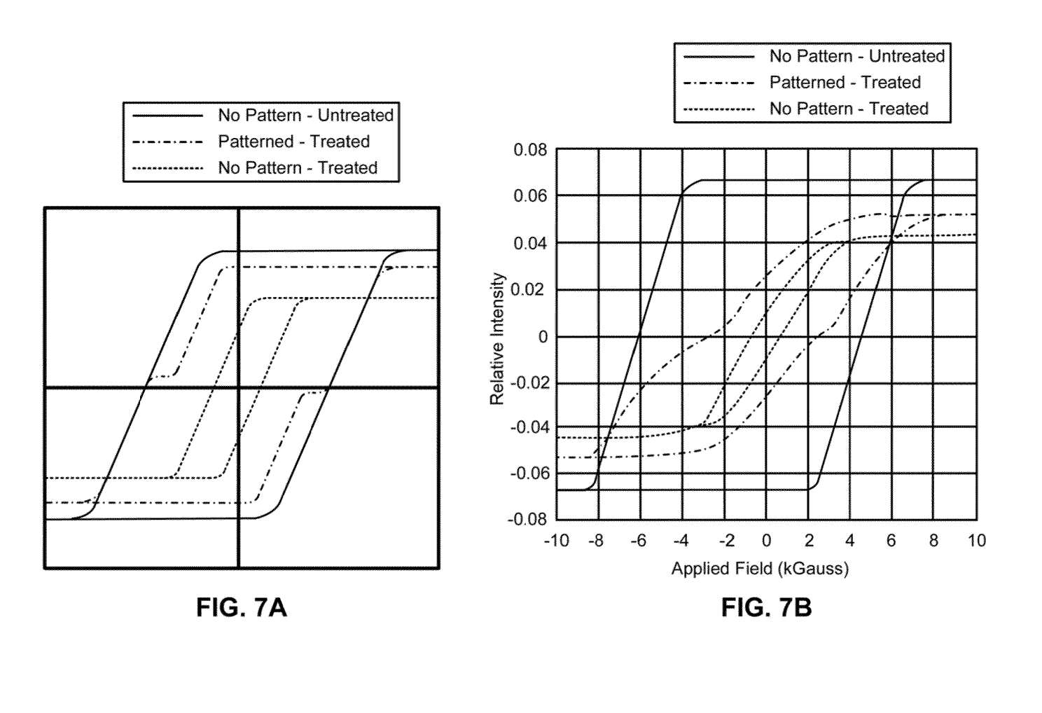

Actual results from measuring magnetic characteristics of a patterned magnetic medium produced according to a method of producing a patterned magnetic medium described herein, according to one embodiment, are shown in FIGS. 7A-7B. FIG. 7A shows a model of the magnetic characteristics which shows that the magnetic characteristics vary according to existence of patterning, no patterning, and no treatment. FIG. 7B shows the results of measuring the magnetic characteristics when a method as described herein, according to one approach, has been used to produce a magnetic recording medium. As is clear from FIG. 7B, the untreated portion exhibits a regular magnetic loop, the treated portion has considerably poorer magnetic characteristics, and the patterned portion has a combination of these magnetic characteristics, in the same way as the model. It was confirmed that the same phenomenon occurred as is shown in FIGS. 6A-6B.

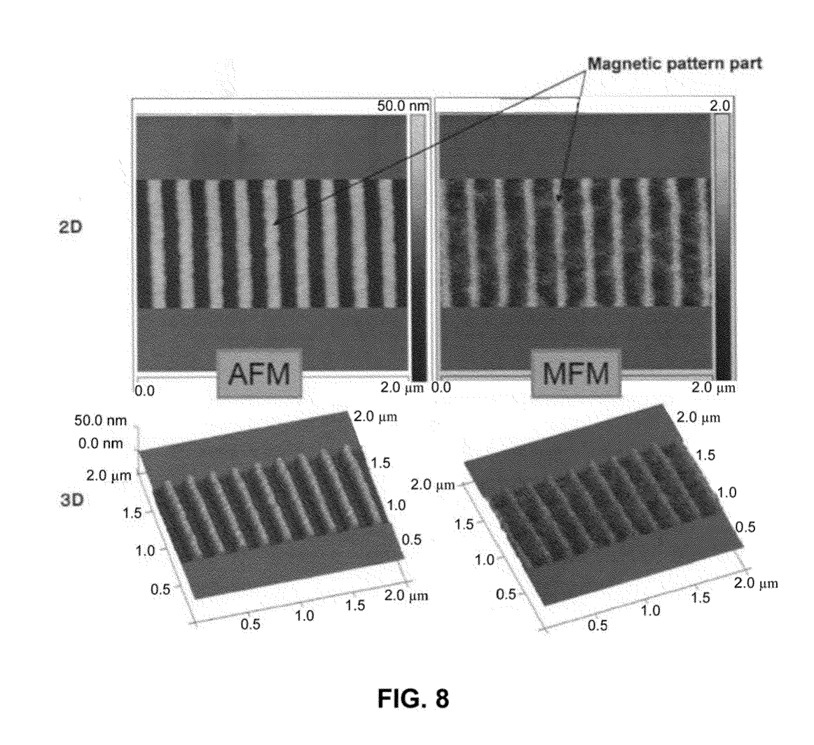

In addition, FIG. 8 shows the results of evaluating the patterned portion of the sample by means of atomic force microscopy (AFM) and magnetic force microscopy (MFM). It was confirmed from these results that the patterned portion which had slight projections according to AFM was magnetic from MFM observations, and the pattern forming methods employing treatment according to embodiments and approaches describe herein are effective.

With regard to the ion energy used in the surface modification treatment, it was confirmed that the same effect may be achieved when the acceleration voltage is within a range from about 500 V maximum to about 50 V minimum. The ion energy used in FIGS. 7A-7B, and 8 was set at 150 eV. Accordingly, there was no damage to the interlayer and the other layers and the shape in the energy category, according to this implementation.

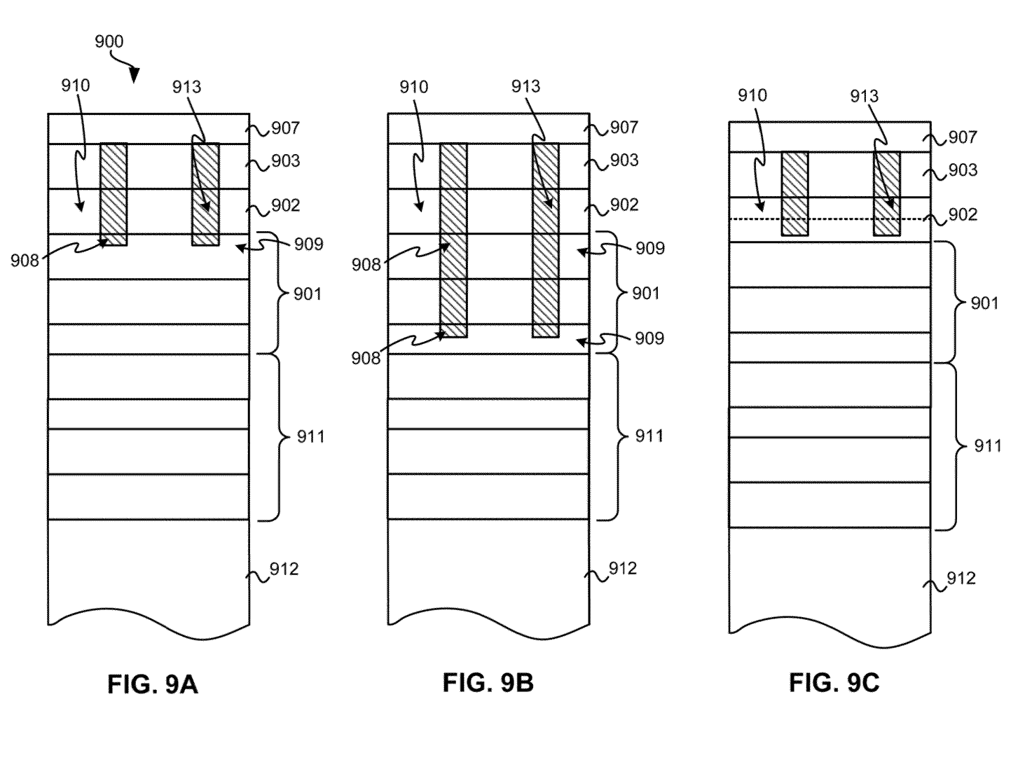

Exemplary embodiments are described below. In these embodiments, a medium was prepared in accordance with the methods described herein according to various embodiments. Also, a comparative example was produced using the conventional method as described previously, without any further treatment, as Comparative Example 1 which was evaluated at the same time as the exemplary embodiments. Furthermore, the layer structure of the media used in the exemplary embodiments is shown in FIG. 9A, comprising, on a nonmagnetic substrate 912, a soft magnetic layer 911, an interlayer 901 for controlling the crystal orientation, a magnetic recording layer 902, a cap layer 903, and a carbon protective layer 907. A modified portion 908 of the interlayer was formed using ion treatment which formed the patterned portion 908 of the interlayer having poor crystal orientation, while a patterned portion 909 having good crystal orientation remained after the ion treatment.

In one embodiment, as shown in FIG. 9A, a patterned magnetic recording medium 900 comprises an interlayer 901 positioned above a nonmagnetic substrate 912, wherein portions 909 of the interlayer have good crystal orientation and are separated by portions 908 of the interlayer which have poor crystal orientation. The medium 900 also comprises a magnetic recording layer 902 positioned above the interlayer 901, wherein the magnetic recording layer 902 is defined by a pattern which comprises magnetic portions 910 having good crystal orientation above the portions 909 of the interlayer having good crystal orientation which are separated by magnetic portions 913 having poor crystal orientation above the portions 908 of the interlayer having poor crystal orientation.

In one approach, the pattern may comprise a bit patterned medium (BPM) pattern, a discrete track medium (DTM) pattern, or any other pattern that would be useful for patterned media construction, as would be known to one of skill in the art upon reading the present descriptions.

In another approach, the portions 908 of the interlayer having poor crystal orientation may comprise a surface or interface that includes at least one doping element or material, such as N, Ar, He, Ne, Kr, Xe, C, and/or O, among others. Furthermore, the portions 909 of the interlayer having good crystal orientation do not substantially contain any impurities, and the portions 908 having poor crystal orientation and the portions 909 having good crystal orientation are separated according to the pattern.

In one embodiment, the magnetic portions 910 of the magnetic recording layer having good crystal orientation may exhibit substantially uniaxial anisotropy and may have about a perpendicular magnetic orientation.

In some approaches, as shown in FIG. 9A, the magnetic recording layer 902 may be positioned directly on the interlayer 901. However, this is not required, as any number of intermediate layers may be present between the interlayer 901 and the magnetic recording layer 902 as would be understood by one of skill in the art.

In further approaches, the patterned magnetic recording medium 900 may further comprise a soft magnetic layer 911 positioned below the interlayer 901, a cap layer 903 positioned above the magnetic recording layer 902, and a protective layer 907 positioned above the cap layer 903, the protective layer 907 possibly comprising diamond-like carbon (DLC) in some approaches.

In one embodiment, the patterned magnetic recording medium 900 may be used in a magnetic data storage system which may include at least one magnetic head, a drive mechanism for passing the patterned magnetic recording medium 900 over the at least one magnetic head, and a controller electrically coupled to the at least one magnetic head for controlling operation of the at least one magnetic head. Of course, the magnetic data storage system may include more components than those described above. Furthermore, it may include any embodiments and/or approaches described in relation to FIG. 1, in some approaches.

Exemplary Embodiment 1 had the structure shown in FIG. 9A, in which an adhesion layer NiTa 15 nm, soft magnetic film CoTaZr 25 nm, and antiferromagnetic coupling (AFC) layers Ru 0.5 nm, CoTaZr 25 nm were formed on the glass substrate 912 as the soft magnetic layer 911, and a film NiCr 5 nm, then a first film Ru 25 nm, second film Ru 5 nm and third film Ru 5 nm were formed as the interlayer 901, after which a resist pattern was formed using nano-imprinting in order to provide a pattern, and the bottom portion was removed and N+ ion treatment, according to embodiments described herein were carried out to form the patterned portion 909 having poor crystal orientation and the patterned portion 910 having good crystal orientation, after which the resist remaining on the surface was removed by reactive ion etching (REE). After this, a first layer CoCrPtSiO₂ 4 nm, a second layer CoCrPtSiO₂ 4 nm, and a third layer CoCrPtSiO₂ 4 nm, were formed in succession as the magnetic layer 902, a cap layer 903 CoCrPtB 3 nm, and a protective COC layer 907 comprising a diamond-like carbon (DLC) film 3 nm were then formed thereon. In Exemplary Embodiment 1, ion treatment was carried out at the uppermost surface of the third Ru film of the interlayer 901.

Exemplary Embodiment 2 had the layer structure shown in FIG. 9B formed by the same steps as in Exemplary Embodiment 1, but the ion treatment was carried out at the very bottom surface of the interlayer (NiCr 5 nm) 901. Exemplary Embodiment 3 likewise had the layer structure shown in FIG. 9C, but the surface of the first layer of the magnetic layer 902 comprising a plurality of layers directly above the interlayer 901 was subjected to ion treatment. In addition, a perpendicular medium (without a magnetic pattern) having a conventional layer structure was prepared as a Comparative Example 2 which was evaluated in the same way.

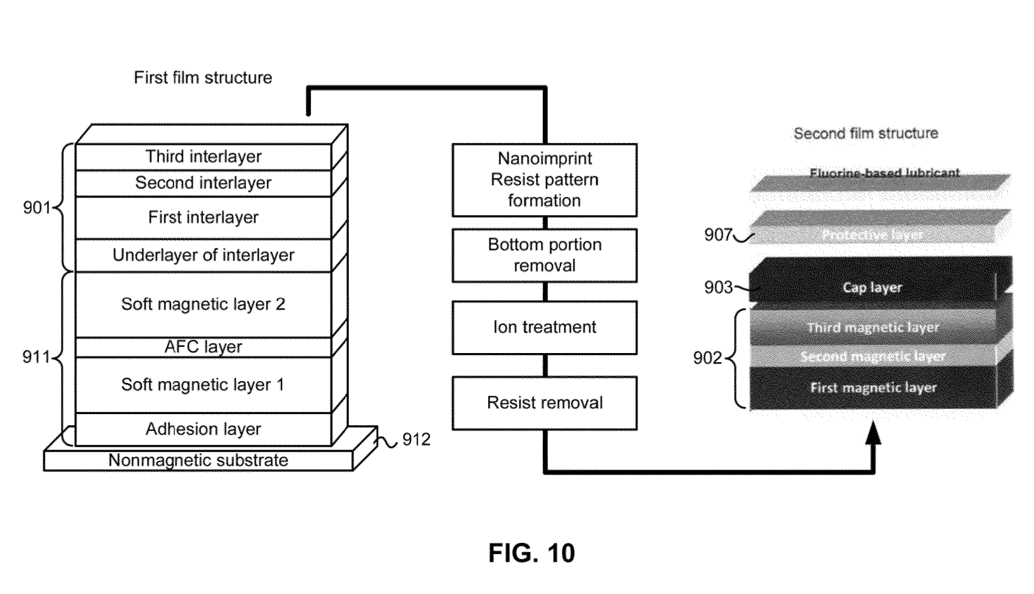

The detailed layer structures used in the exemplary embodiments are shown in FIG. 10 according to one embodiment. As a standard process, a glass substrate (65 mm, 0.635 mmt) was used for the nonmagnetic substrate, and a soft magnetic layer was formed first comprising NiTa 15 nm as an adhesion layer, a soft magnetic film CoTaZr 25 nm, and AFC layers Ru 0.5 nm and CoTaZr 25 nm, and then an interlayer was formed comprising a film NiCr 5 nm, then a first film Ru 10 nm, second film Ru 5 nm and third film Ru 5 nm. After this, a resist pattern was formed by nano-imprinting, the bottom portion of the pattern was removed using oxygen RIE, then N+ ion treatment was carried out using an ion gun, and the imprint resist was removed using H₂-RIE. After this, the magnetic layer comprising a first layer CoCrPtSiO₂ 4 nm, second layer CoCrPtSiO₂ 4 nm and third layer CoCrPtSiO₂ 4 nm in succession, a cap layer CoCrPtB 3 nm, and a COC layer 3 nm comprising a DLC film were formed in succession.

The resist pattern was a circumferential resist pattern formed with a width of 15 nm and a pitch of 25 nm using an imprint apparatus. Also, the ion treatment in these exemplary embodiments was carried out using an ion gun which employed microwave discharge for the plasma source, with nitrogen gas being introduced and treatment being carried out at a constant ion acceleration voltage of −150 V. The treatment time was 30 seconds.

After this, the imprint resist was removed by RIE with the introduction of a mixed He/H₂ gas using an RIE apparatus. After this, the films were formed in succession from the magnetic film, and a fluorine-based lubricant was applied to 10 angstroms, deep cleaning was carried out to remove particles, etc., and an evaluation was carried out.

For the evaluation, the coercive force Hc and also Hn, Hs were measured as the magnetic characteristics of the patterned part using a Kerr apparatus, and the results were compared. Furthermore, the flying properties of the magnetic head which have a large effect on the reliability and RW characteristics were evaluated by measuring the total hit count (total number per surface) produced by an AE sensor with the flying height distance at 10 nm and 5 nm during head seek in a radial range of 18 mm-29 mm on a measurement board. Furthermore, the yields for 30 media under conditions when the magnetic head was flying at 5 nm and 3 nm were compared using the same method.

The results are shown in Table 1, below.

TABLE 1

| | Magnetic Character- | | | | | | |
|---|---|---|---|---|---|---|---|
| | istics (Kerr) | | | Head Flying | | Yield (%) | |
| | Hc | Hn | Hs | Properties (HT) | | FLT | FLT |
| Item | (Oe) | (Oe) | (Oe) | 10 nm | 5 nm | (5 nm) | (3 nm) |
| Ex. Emb. 1 | 5100 | 2180 | 8850 | 1 | 3 | 90 | 87 |
| Ex. Emb. 2 | 5030 | 2190 | 8810 | 0 | 1 | 94 | 89 |
| Ex. Emb. 3 | 5120 | 2200 | 8786 | 1 | 1 | 92 | 90 |
| Comp. Emb. 1 | 4300 | 3240 | 6850 | 100 | 1500 | 4.3 | 0 |
| Comp. Emb. 2 | 5000 | 2200 | 8800 | 2 | 4 | 92 | 88 |

It is clear from the results shown in Table 1 that the evaluation results from Exemplary Embodiments 1, 2, and 3 (Ex. Emb. 1, 2, 3) in accordance with embodiments described herein were better in all cases than those of Comparative Example 1 (Comp. Ex. 1) in terms of magnetic characteristics, head flying properties and yield, and there was equivalent data in comparison with Comparative Example 2 (Comp. Ex. 2) which was a conventional perpendicular magnetic disk. Furthermore, it is believed that the presence of a magnetic layer having poor crystal orientation between the magnetic layer patterns was a drawback with regard to signal-to-noise ratio (S/N) compared with the conventional solid-film perpendicular medium of Comparative Example 2, but it was possible to reduce magnetic interference between adjacent tracks and adjacent bits using the magnetic patterning, so it was understood that the S/N was actually somewhat better than in the conventional Comparative Example 2. Furthermore, the magnetic interference between adjacent tracks was lessened, so an ATI reducing effect may also be anticipated in some embodiments.

That is to say, it is clear that the embodiments and approaches presented herein make it possible to maintain the R/W characteristics and reliability which are important in a magnetic recording medium, while achieving at least equivalent magnetic characteristics and flying characteristics when compared to a conventional perpendicular medium while allowing for the formation of a good magnetic pattern.

It is also clear that the modifying effect afforded by the treatment according to embodiments and approaches presented herein have the same effect regardless of whether it is applied at the uppermost surface of the interlayer or the lowermost layer, or at the surface of the first layer of the magnetic layer.

The ion gun used in the exemplary embodiments employed microwave discharge, but the embodiments and approaches presented herein are in no way limited to an ion gun in particular, or an ion gun that uses microwave discharge in order to be effective, and an RF method, magnetron method, or any other method as known in the art may be used.

Also, N₂ was used as the treatment gas in the exemplary embodiments, but the embodiments and approaches presented herein are not limited by the type of gas, and it has been confirmed that the same effect may be achieved by using at least one element selected from the group comprising N, Ar, He, Ne, Kr, Xe, C and/or O.

The layer structure and process according to some embodiments therefore make it possible to allow high-density magnetic recording and to provide a very reliable magnetic recording medium.

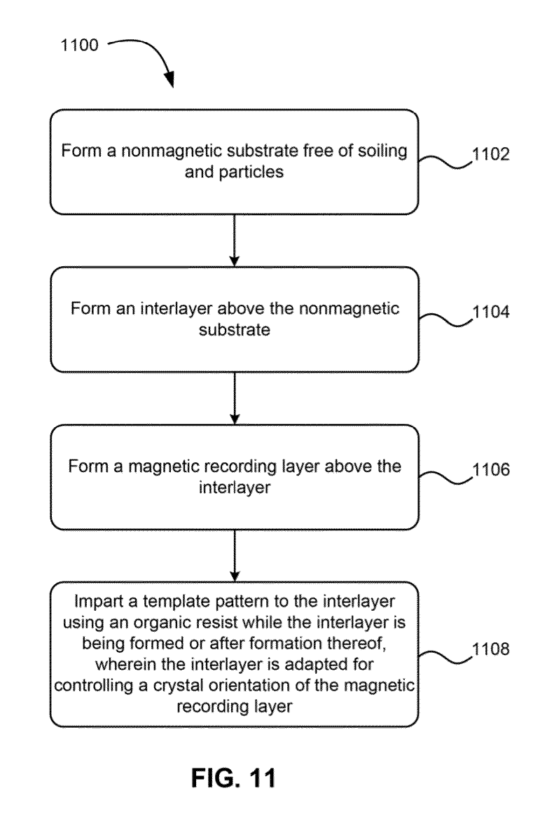

Referring to FIG. 11, a method 1100 is shown according to one embodiment. The method 1100 may be carried out in any desired environment, including those shown in FIGS. 1-10, among others. More or less operations may be carried out in accordance with method 1100 according to various embodiments, as would be understood by one of skill in the art upon reading the present descriptions.

In operation 1102, a nonmagnetic substrate free of soiling and particles is formed, using any method known in the art, such as plating, sputtering, etc. The cleaning may be performed after formation or during formation, and may substantially remove all impurities, debris, etc., such that the substrate is ready to have additional layers formed thereon.

In operation 1104, an interlayer is formed above the nonmagnetic substrate. The interlayer may comprise one or more layers. The interlayer may comprise any suitable material as would be known to one of skill in the art, including but not limited to those described herein, such as Ru and doped-Ru, in portions, in layers, or completely, according to various approaches.

In operation 1106, a magnetic recording layer is formed above the interlayer. The magnetic recording layer may comprise one or more layers. Any suitable material may be used for the magnetic recording layer as would be known to one of skill in the art, including but not limited to those described herein.

In one embodiment, the magnetic recording layer may be formed directly on the interlayer, such as under a vacuum.

In operation 1108, a template pattern is imparted to the interlayer using an organic resist while the interlayer is being formed or after formation thereof. The interlayer is adapted for controlling a crystal orientation of the magnetic recording layer in some approaches. Any method of imparting the pattern may be used, including but not limited to those described herein according to various embodiments. For example, in some approaches, the template pattern may comprise a BPM pattern, a DTM pattern, or any other desired pattern.

In one approach, imparting the template pattern to the interlayer may include treating portions of a surface or interface of the interlayer through the organic resist template pattern with an ionized gas. The portions of the surface or interface of the interlayer which are treated are located at positions where the organic resist has a minimum thickness, since this allows the gas to penetrate the interlayer at these positions. This results in these portions of the interlayer to have poor crystal orientation, as opposed to the untreated portions which exhibit good crystal orientation.

The treatment with an ionized gas may include, in one embodiment, accelerating the ionized gas using low energy of about 500 V or less toward the surface or interface of the interlayer under a vacuum. In this or any other embodiment, the gas may be selected from a group consisting of at least one of: N, Ar, lie, Ne, Kr, Xe, C, and O. The portions of the surface of the interlayer that are treated and portions of the interlayer which are untreated may adhere to the template pattern, in some approaches.

In a further approach, portions of the magnetic recording layer having, good crystal orientation will be formed above portions of the interlayer that are untreated, and portions of the magnetic recording layer having poor crystal orientation will be formed above the treated portions of the interlayer such that the template pattern is imparted to the magnetic recording layer as portions with good or poor crystal orientation.

In addition, the portions of the magnetic recording layer having good crystal orientation may exhibit uniaxial anisotropy and may have a perpendicular magnetic orientation, in preferred embodiments.

After treatment, the organic resist may be removed using any method known in the art, such as reactive ion etching, etc.

In addition, in some embodiments, a soft magnetic layer may be formed below the interlayer, a cap layer may be formed above the magnetic recording layer, and a protective layer may be formed above the cap layer. Of course, other layers are also possible, such as an AFC layer, multiple layers already described, an adhesion layer, etc.

While various embodiments have been described above, it should be understood that they have been presented by way of example only, and not limitation. Thus, the breadth and scope of an embodiment of the present invention should not be limited by any of the above-described exemplary embodiments, but should be defined only in accordance with the following claims and their equivalents.

What is claimed is:

1. A patterned magnetic recording medium, comprising:
an interlayer positioned above a nonmagnetic substrate, wherein portions of the interlayer have good crystal orientation and are separated by portions of the interlayer which have poor crystal orientation; and
a magnetic recording layer positioned above the interlayer, wherein the magnetic recording layer is defined by a pattern which comprises magnetic portions having good crystal orientation above the portions of the interlayer having good crystal orientation which are separated by magnetic portions having poor crystal orientation above the portions of the interlayer having poor crystal orientation.

2. The patterned magnetic recording medium as recited in claim 1, wherein the pattern comprises a bit patterned medium (BPM) pattern or a discrete track medium (DTM) pattern.

3. The patterned magnetic recording medium as recited in claim 1,
wherein the portions of the interlayer having poor crystal orientation comprise a surface or interface that includes at least one element selected from a group consisting of: N, Ar, He, Ne, Kr, Xe, C, and O, and
wherein the portions of the interlayer having good crystal orientation contain substantially no impurities,
wherein the portions having poor crystal orientation and good crystal orientation are separated according to the pattern.

4. The patterned magnetic recording medium as recited in claim 1, wherein the magnetic portions of the magnetic recording layer having good crystal orientation exhibit substantially uniaxial anisotropy and have about a perpendicular magnetic orientation relative to a film of deposition thereof.

5. The patterned magnetic recording medium as recited in claim 1, wherein the magnetic recording layer is positioned directly on the interlayer.

6. The patterned magnetic recording medium as recited in claim 1, further comprising:
a soft magnetic layer positioned below the interlayer;
a cap layer positioned above the magnetic recording layer; and
a protective layer positioned above the cap layer, the protective layer comprising diamond-like carbon (DLC).

7. The patterned magnetic recording medium as recited in claim 1, wherein the portions of the interlayer having poor crystal orientation only extend for a portion of a thickness of the interlayer from an upper surface thereof towards a lower surface thereof.

8. The patterned magnetic recording medium as recited in claim 1, wherein the portions of the interlayer having poor crystal orientation have ions implanted therein.

9. A magnetic data storage system, comprising:
at least one magnetic head;
the patterned magnetic recording medium as recited in claim 1;
a drive mechanism for passing the patterned magnetic recording medium over the at least one magnetic head; and
a controller electrically coupled to the at least one magnetic head for controlling operation of the at least one magnetic head.

10. A method for producing a patterned magnetic recording medium, the method comprising:
forming a nonmagnetic substrate free of soiling and particles;
forming an interlayer above the nonmagnetic substrate;
forming a magnetic recording layer above the interlayer; and
imparting a template pattern to the interlayer using an organic resist while the interlayer is being formed or after formation thereof,
wherein the interlayer is adapted for controlling a crystal orientation of the magnetic recording layer.

11. The method as recited in claim 10, further comprising:
forming a soft magnetic layer below the interlayer;
forming a cap layer above the magnetic recording layer; and
forming a protective layer above the cap layer,
wherein the magnetic recording layer is formed directly on the interlayer under a vacuum.

12. The method as recited in claim 10, wherein the template pattern comprises a bit patterned medium (BPM) pattern or a discrete track medium (DTM) pattern.

13. The method as recited in claim 10, wherein imparting the template pattern to the interlayer comprises:
treating portions of a surface or interface of the interlayer through the organic resist template pattern with an ionized gas, wherein the portions of the surface or interface of the interlayer which are treated are located at positions where the organic resist has a minimum thickness.

14. The method as recited in claim 13, wherein the treating with an ionized gas comprises:
accelerating the ionized gas using low energy of about 500 V or less toward the surface or interface of the interlayer under a vacuum, wherein the gas is selected from a group consisting of at least one of: N, Ar, He, Ne, Kr, Xe, C, and O.

15. The method as recited in claim 14, wherein portions of the magnetic recording layer having good crystal orientation are formed above portions of the interlayer that are untreated, and wherein portions of the magnetic recording layer having poor crystal orientation are formed above the treated portions of the interlayer such that the template pattern is imparted to the magnetic recording layer as portions with good or poor crystal orientation.

16. The method as recited in claim 15, wherein the portions of the magnetic recording layer having good crystal orientation exhibit uniaxial anisotropy and have a perpendicular magnetic orientation.

17. The method as recited in claim 13, wherein the portions of the surface of the interlayer that are treated and portions of the interlayer which are untreated adhere to the template pattern.

18. The method as recited in claim 13, further comprising removing the organic resist after the ion treatment.

19. A method for producing the patterned magnetic recording medium as recited in claim 1, the method comprising:
forming a nonmagnetic substrate free of soiling and particles;
forming an interlayer above the nonmagnetic substrate;
forming a magnetic recording layer directly on the interlayer under a vacuum; and
imparting a template pattern to the interlayer using an organic resist while the interlayer is being formed or after formation thereof by treating portions of a surface or interface of the interlayer through the organic resist template pattern with an ionized gas,
wherein the portions of the surface or interface of the interlayer which are treated are located at positions where the organic resist has a minimum thickness,
wherein the interlayer is adapted for controlling a crystal orientation of the magnetic recording layer,
wherein the template pattern comprises a bit patterned medium (BPM) pattern or a discrete track medium (DTM) pattern, and
wherein the portions of the surface of the interlayer which are treated and portions of the interlayer which are untreated adhere to the template pattern.

20. The method as recited in claim 19, wherein the treating with an ionized gas comprises:
accelerating the ionized gas using low energy of about 500 V or less toward the surface or interface of the interlayer under a vacuum,
wherein the gas is selected from a group consisting of at least one of: N, Ar, He, Ne, Kr, Xe, C, and O,
wherein portions of the magnetic recording layer having good crystal orientation are formed above portions of the interlayer that are untreated,
wherein portions of the magnetic recording layer having poor crystal orientation are formed above the treated portions of the interlayer such that the template pattern is imparted to the magnetic recording layer as portions with good or poor crystal orientation, and
wherein the portions of the magnetic recording layer having good crystal orientation exhibit uniaxial anisotropy and have a perpendicular magnetic orientation.
